(19) United States
(12) Patent Application Publication
(10) Pub. No.: US 2011/0114202 A1
(43) Pub. Date: May 19, 2011

(54) Water Flow Monitor

(76) Inventor: John Goseco, Cost Mesa, CA (US)

(21) Appl. No.: 12/944,107

(22) Filed: Nov. 11, 2010

Related U.S. Application Data
(60) Provisional application No. 61/261,202, filed on Nov. 13, 2009.

(51) Int. Cl. F16K 31/02

(52) U.S. Cl. 137/487.5

(57) ABSTRACT

A system may include a controllable shut-off valve disposed in a water supply line and a water flow sensor disposed in the water supply line. A controller may be coupled to the shut-off valve and the sensor. The controller may be configured to receive information indicative of water flow from the sensor and to instruct the shut-off valve to shut off the water supply line in the event of unusual water usage.

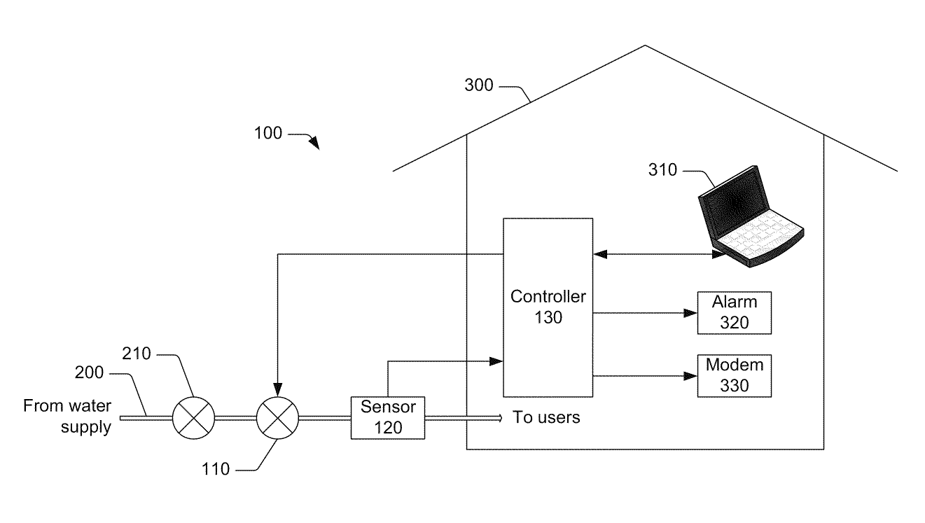

### RELATED APPLICATION INFORMATION

This patent claims priority from provisional patent application No. 61/261,202 filed on Nov. 13, 2009, entitled “WATER FLOW MONITOR”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to monitor water usage.

2. Description of the Related Art

Water damage losses are one of the biggest costs for insurance companies. Additionally, fresh water is a limited resource that may be wasted when a pipe breaks and water runs for days if not weeks or even months. Irrigation systems typically have valves than can stick open and run continuously. The same goes for toilets. Automatic swimming pool fill system can fail and flood adjacent spaces, causing damage to landscaping, adjacent structures and pool skirt and decking.

### DESCRIPTION OF THE DRAWINGS

The FIGURE shows a water use monitoring and control system.

### DETAILED DESCRIPTION

### Description of Apparatus

The FIGURE shows a water use monitoring and control system 100. The system 100 may include a controllable shut-off valve 110 disposed along a water supply line 200 that brings water to an establishment 300. The establishment 300 may be a house as shown, a business, a farm, or other user. The establishment 300 may be a recreational vehicle or a boat or other vehicle that has a plumbing system, in which case the water supply line 200 may connect to a water tank (not shown) within the vehicle. The water supply line 200 may be equipped with an existing manual shut-off valve 210. The controllable shut-off valve 110 may also be manually operable.

The system 100 may include a sensor 120 disposed along the water supply line 200 and a controller 130 coupled to the shut-off valve 110 and the sensor 120. The controller 130 may be located remotely from the shut-off valve 110 and/or the sensor 120. The controller 130 may be coupled to the shut-off valve 110 and/or the sensor 120, for example, by electrical cables or wirelessly. The sensor 120 may be integrated with the shut-off valve 110 or the controller 130.

The system 100 may monitor the water supplied to the establishment 300 and watch for unusual water demand. The sensor 120 may sense a water flow rate in the water supply line 200. The controller 130 may receive water flow information from the sensor 120 and instruct the shut-off valve 110 to shut off the water supply to the establishment 300 in the event of unusual water flow. The controller 130 may be programmable so a user can decide when water flow should be monitored and also for how long in duration water flow should be considered normal. The controller may be programmable to define multiple combinations of water flow rate and time period that are considered normal.

For example, a landscape or agricultural irrigation system may be programmed to supply water only at specific times and on specific days of the week, such as between the hours of 8 to 10 AM on Monday, Wednesday, and Friday. The controller 130 may be programmed to ignore the water usage at that time and day. The controller 130 may be capable of learning the normal water flow during operation of the irrigation system. For further example, the controller may be programmed to allow a high water flow rate for a short period of time, such as a few minutes, to allow for coincidental use of two or more bathrooms in a home. Another example would be bathing time for a family. A home owner would determine the maximum amount of time it would take to take a shower or fill a tub and program that into the controller 130. For example, the home owner may determine that they would never need more than an hour so the controller may be programmed to shut off the water supply if demand lasted for more than an hour.

The controller 130 may include or be coupled to a manual override button (not shown) to interrupt the operation of the system 100. The controller may be coupled to keypads or data entry devices (not shown) at water usage points such as a laundry room and/or bathrooms to allow users to temporarily change the programmable water use limits. The controller may include or be coupled to an “away” button that causes the normal controller operation to be suspended and sets a very short time limit on any water use, with the optional exception of irrigation system use. The “away” button could be used, for example, if a family was going on vacation and anticipated no water use (other than irrigation) while they were gone.

The system 100 may monitor the water pressure in the water supply line 200 to protect the pipes and other plumbing within the establishment 300 from excessive pressure. The sensor 120 may sense the pressure within the water supply line 200. The controller 130 may receive water pressure information from the sensor 120 and instruct the shut-off valve 110 to shut off the water supply to the establishment 300 in the event the water pressure rises above a predetermined threshold level. The controller 130 may then reopen the shut-off valve 110 after a delay period which may be, for example, one minute or two minutes or some other period. It the water pressure in the water supply line has returned to a normal value, the shut-off valve 110 may remain open. If the pressure is still above the predetermined threshold level, the controller 130 may shut the shut-off valve 110 again and wait for an equal or longer interval. If the pressure in the water supply line 200 remains above the predetermined threshold value for more than a predetermined time period, controller 130 may keep the shut-off valve 110 closed. The controller 130 may also alert a user or maintenance personnel of the problem.

The system 100 may be programmable to test the plumbing system within the establishment 300 for leaks. To test for leaks, the controller 130 may close the shut-off valve 110 and monitor pressure information received from the sensor 120. If the pressure remains constant for a predetermined time period, for example ten minutes, the plumbing system is considered to be free of leaks, and the shut-off valve 110 may be reopened. If the pressure drops during the predetermined time period, the controller 130 may optionally repeat the test to confirm the result. If the pressure drop is confirmed, the controller 130 may keep the shut-off valve 110 closed and alert a user and/or maintenance personnel of the problem. The system may be programmed to perform pressure tests at periodic intervals, such as daily, at times when water use is likely to be zero.

The system 100 may include microphone flow sensors (not shown) attached to all water fixtures within the establishment 300. Microphone flow sensors essentially “listen” for water flow in the associated water fixtures. When the sensor 120 provide information indicating a non-zero water flow rate to the controller 130, the controller 130 may interrogate the microphone flow sensors to determine where the water is being used. The controller may then use the responses from the microphone flow sensors to maintain historical records on where water is being used within the establishment 300. When the system 100 includes the optional microphone flow sensors, the controller 130 may continuously monitor for leaks by comparing the information from the sensor 120 and the microphone flow sensors. When the sensor 120 detects water flow and none of the microphone flow sensors hear water flowing their respective fixtures, the controller may determine nearly instantly that a leak has occurred. The controller 130 may then close the shut-off valve 110 and alert a user and/or maintenance personnel as previously described.

The system 100 may include at one or more water temperature sensors (not shown) attached pipes or other components of the plumbing system within the establishment 300. The controller 130 may receive information from the one or more water temperature sensors. When the controller 130 determines that there is a risk of water freezing within the plumbing system, the controller may initiate action to prevent freezing if possible. For example, if there is hot water remaining within the plumbing system, the controller 130 may activate a pump (not shown) to circulate hot water throughout the plumbing system. In the event that freezing is about to occur, the controller 130 may close the shut-off valve 110 and open a drain valve (not shown) to allow the plumbing system to drain.

The system 100 may be integrated with a hot water recirculation system (not shown). The hot water recirculation system may include a pump connected between the hot and cold supply lines of a sink or other fixture furthest away from a hot water heater within the establishment. The pump may be equipped with a one-way valve that prevents cold water from flowing into the hot side. A remote switch in the bathroom may allow a user to activate the pump to circulate the water from the hot water side to the cold water supply. A thermostat may stop operation of the pump when the water at the hot water side is actually hot. while the water recirculation pump is running, the controller 130 may close the shut-off valve 110. Because the recirculation pump doesn't have to fight water pressure from the water supply line, a smaller and lower power recirculation pump may be used. For example, a recirculation pump operable from rechargeable battery may be used, instead of a pump operating from 120-volt AC power, which is far safer in a bathroom situation.

The controller 130 may come in different models having different programming options from basic manually programming to system that may be fully integrated with security systems or networks. The controller 130 may be modular in construction to allow expansion of the functionality of the system 100 using plug-in modules. The controller 130 may be programmable via an interface to a computing device 310. The controller 130 may be programmable from an application running on a wireless device such as a table computer or a smart telephone. The controller 130 may be coupled to or include a phone modem 330 so the system can send alerts to a user or to maintenance personnel via a telephone call, instant message, e-mail, or some other communication. The controller 130 may be coupled to or include an audible and/or visible alarm 320.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system comprising:
a controllable shut-off valve disposed in a water supply line
a water flow sensor disposed in the water supply line
a controller coupled to the shut-off valve and the sensor, the controller configured to
receive information indicative of water flow from the sensor
instruct the shut-off valve to shut off the water supply line in the event of unusual water usage.
